(19) United States
(12) Patent Application Publication
(10) Pub. No.: US 2022/0071443 A1
(43) Pub. Date: Mar. 10, 2022

(54) SYSTEM FOR CONTROLLING COOKING AS A FUNCTION OF ENVIRONMENTAL AIR DENSITY

(71) Applicant: TECHNOLOGY LICENSING CORPORATION, Fort Lauderdale, FL (US)

(72) Inventors: BEN KOETHER, FORT LAUDERDALE, FL (US); EDWARD MUSIAL, MONROE, CT (US); MIKE KEEFE, BROOKFIELD, CT (US)

(21) Appl. No.: 17/466,493

(22) Filed: Sep. 3, 2021

Related U.S. Application Data
(60) Provisional application No. 63/075,514, filed on Sep. 8, 2020.

(51) Int. Cl. A47J 36/32; G01C 5/06; A47J 37/12; A23B 4/052

(52) U.S. Cl. CPC A47J 36/32; G01C 5/06; A23V 2002/00; A23B 4/052; A47J 37/1266

(57) ABSTRACT

The system for controlling cooking as a function of environmental air density includes a cooking appliance operating in accordance with a recipe. An air density detector is operatively coupled to the cooking appliance. The air density detector determines an air density at the cooking appliance and outputs an air density signal. A processor in communication with the air density detector and the cooking appliance receives the air density signal. The processor outputs an adjustment recipe to the cooking appliance in response to the air density signal and the cooking appliance operates in accordance with the adjustment recipe.

### CROSS REFERENCE TO RELATED APPLICATION

This application claims the benefit of U.S. Provisional Application No. 63/075,514 filed on Sep. 8, 2020, the entire disclosure of which is hereby incorporated in its entirety.

### BACKGROUND OF THE INVENTION

The present invention relates to a control system for a cooking appliance, and more particularly, a control system for changing the operation of the cooking appliance to account for changes in altitude, weather, and the resulting air density.

Cook times and cook temperatures for preparing food change as a function of the environment in which they are prepared. Therefore, they change as a function of altitude because air density changes as a function of altitude. By way of non limiting example, water boils at 215° F. in Death Valley, but boils at 160° F. on Mount Everest. It follows that water boils at 202° F. in Denver. All of these can affect anything from boiling off water in oil for safety in a commercial fryer to the time needed to cook foods in water-based recipes.

In a convection oven type cooking appliance the texture of the food such as bread, by way of non-limiting example, is a function of exposure of the food item to a certain quantity of heated air over time. Generally, at lower pressures, lower air densities, foods tend to dry out faster, doughs rise faster and liquids evaporate faster. Because the air has a thermal density as a function of volume, the exposure time for the food item can change with air density as the mass of air flowing through the oven decreases or increases with air density. It is known that the air density, and resulting volume of air throughput decreases as a function of increased altitude and corresponding air pressure, and increases a function of decreased altitude changing everything from cook times, to proofing time, to creating the browning affect.

The problem becomes even more acute where heated air is used not just for cooking, but for flavoring of the food. In a smoker, or closed barbecue, the smoke, the density of which changes with the density of the environment, is used not only to heat the food, but to flavor the food is well. Both the cooking time and the flavor can change as a function of the density of the air in the environment in which the food is cooked.

It is known in the prior art to provide altitude specific recipes. Accordingly, there are books with general recipes which change as a function of altitude, or instructions for altering a recipe for a given altitude. Therefore there would be one recipe for Death Valley, a second recipe for the same product at Mount Everest, and a third recipe for the same food product cooked in Denver. This prior art solution has been satisfactory, however it does not account for cooking in locations between areas for which recipes have been determined, or where the environment can change on a daily basis as a function of weather. Additionally, where instructions are given for altering the recipe, or the food preparation occurs outside of one of the designated areas corresponding to an adjusted recipe, human input and judgment is required which can lead to error, and even if done correctly, inconsistencies. It is a one size fits all solution which does not recognize human error, climate variations at a same location, or even variations at an altitude between locations.

Additionally, the prior art accounted for altitude which is somewhat correlated to air density, but the fixed recipes do not account for changing air density conditions such as rainy days compared to sunny days, and winter days compared to summer days; all of which can further change the parameters of a recipe. Therefore, food preparers operating cooking appliances, under identical recipes and instruction, end up with inconsistent food products between themselves and even between different batches cooked on the same appliance in different environmental conditions.

Accordingly, there is a need for a control system for a cooking appliance that can account for changes in environmental air density to change the recipe under which the cooking appliance operates to ensure conformity of finished product.

### SUMMARY OF THE INVENTION

The system for controlling cooking as a function of environmental air density includes a cooking appliance operating in accordance with a recipe. An air density detector is operatively coupled to the cooking appliance. The air density detector determines an air density at the cooking appliance and outputs an air density signal. A processor in communication with the air density detector and the cooking appliance receives the air density signal. The processor outputs an adjustment recipe to the cooking appliance in response to the air density signal and the cooking appliance operates in accordance with the adjustment recipe.

### BRIEF DESCRIPTION OF THE DRAWINGS

The features and advantages of the present invention will become more readily apparent from the following detailed description of the invention in which like elements are labeled similarly and in which:

FIG. 1 is a schematic drawing of the system for controlling a cooking appliance in accordance with the invention; and

FIG. 2 is a flowchart for the operation of the system for controlling a cooking appliance in accordance with the invention.

### DETAILED DESCRIPTION OF THE PREFERRED EMBODIMENTS

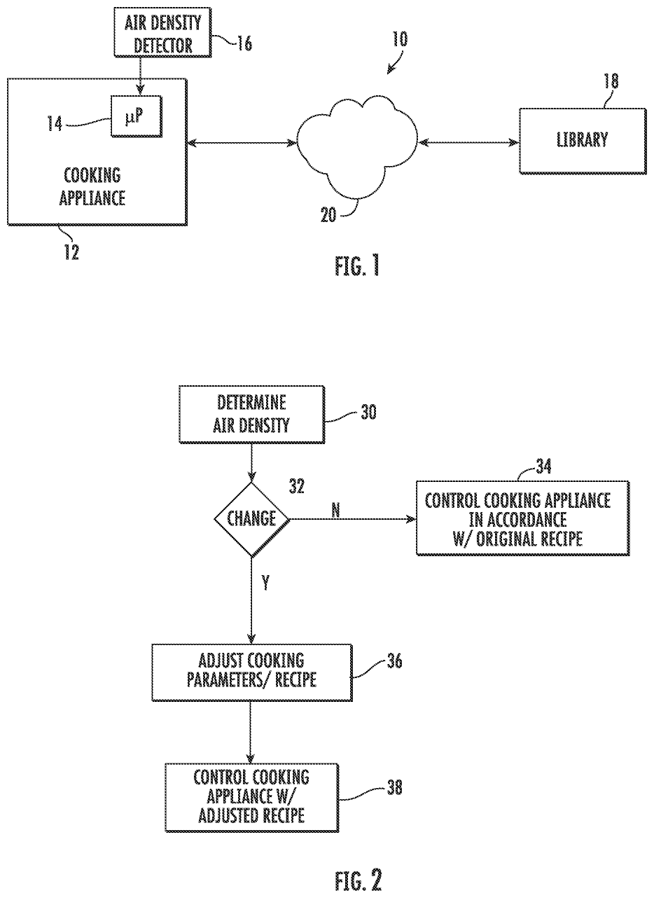

Reference is initially made to FIG. 1 in which a schematic diagram for a system 10 for controlling a cooking appliance to account for environmental air density in accordance with the invention is shown. System 10 includes a cooking appliance 12 which operates under the control of a microprocessor 14. Microprocessor 14 executes cooking parameters in the form of a recipe to control the operation of cooking appliance 12. By way of example, the most commonly controlled parameters are time and temperature as a function of inputs, or stored recipes, to which microprocessor 14 has access. Cooking appliance 12 may be a fryer, a convention oven, or a proofer by way of example; all of which operate in accordance with time and temperature parameters.

An air density detector 16 is operatively coupled to cooking appliance 12. Air density detector 16 is located at the same location as cooking appliance 12 to detect the air density of the environment in which cooking appliance 12 is located. Air density detector 16 may be in an exemplary non-limiting embodiment, a barometer which detects air density as a function of environmental air pressure, or an altimeter which enables determination of air density as a function of the altitude at which the cooking appliance 12 is located. Air density detector 16 may be a GPS device or the like which determines the latitude and longitude of the cooking appliance 12, and working with a look up table or the like accessible by microprocessor 14, determines the air density at that location. Air density detector 16 may be formed integrally with the cooking appliance 12, or may be a separate item, in the same environment as cooking appliance 12, communicating either wirelessly, or in a hardwired fashion with cooking appliance 12.

A recipe for controlling cooking appliance 12 is either stored at microprocessor 14, or accessible to microprocessor 14. The recipe is associated with a known density of air; the reference density. The reference density is the anticipated density of air at the cook location. A recipe may have several refence densities mapped to one or more respective anticipated cooking altitudes. Air density detector 16 outputs an air density signal to microprocessor 14 indicating the air density measurement for the environment in which cooking appliance 12 resides. Microprocessor 14 compares the air density value of the air density signal and determines whether there is a change between the value of the air density signal and the air density associated with the stored recipe or not.

There is a determinable mathematical correlation between changes in air density and a required modification to a recipe, to factors such as boil temperature as a function of altitude. Therefore, in a first non-limiting embodiment, microprocessor 14 operates in accordance with an algorithm which modifies the stored recipe parameters, such as time and temperature, as a function of the change in air density relative to the stored base recipe. Microprocessor 14 then controls the cooking operation of the cooking appliance in accordance with a modified recipe as required.

In a second non-limiting embodiment of the invention, microprocessor 14 is in communication with a library 18. Library 18 may store a.) recipes as a function of different altitudes and/or air densities, b.) a conversion lookup table for determining changes in parameters as a function of altitude and/or air density, or c.) the algorithm to be utilized by microprocessor 14 for calculating changes in a stored recipe's parameters. Library 18 may communicate directly with microprocessor 14 wirelessly utilizing radio communication, Bluetooth communication, Wi-Fi communication, or cellular communication, as well as being hardwired to each other. Communication may also occur across the cloud 20. In a preferred embodiment, it is microprocessor 14 which communicates bi-directionally with library 18, but communication for some or all processing may occur with a smart air density detector 16.

Reference is now made to FIG. 2 in which the method of operation of system 10 in accordance with the invention is provided. As is known in the art, a cooking appliance 12 such as a fryer is programmed with recipes for cooking a variety of foods. The recipes have parameters for the time and temperature of the cooking medium associated with each different food. The initially programmed recipe is a recipe which optimizes food preparation at a lowest common denominator altitude (environmental air density); such as sea level which incorporates the population centers of the East Coast and West Coast in the United States by way of example. In a step 30 air density detector 16 detects the air density as a function of altitude or air pressure and outputs an air density signal to microprocessor 14.

In a step 32 microprocessor 14 determines whether the air density indication signal corresponds to a change in an air density different from the air density at which the currently stored recipe corresponds. If not, then in a step 34 no adjustment is made to the stored recipe, and cooking appliance 12 is operated in accordance with the original recipe stored at microprocessor 14.

If microprocessor 14 determines in step 32, that there is a difference in air density sufficient to affect food quality if cooked with the originally stored recipe, then microprocessor 14 changes the recipe to be operated upon in a step 36. In one embodiment of the invention, microprocessor 14 utilizes an algorithm to change the time and/or temperature of a fryer operation as a function of the air density indication signal. The microprocessor 14 may utilize the differential between the expected altitude, air pressure or corresponding air density to determine the required recipe parameter adjustment, or may use the absolute value of the measured altitude, air pressure or corresponding air density to adjust the recipe. Therefore, in the fryer example the time period for boiling off water in the frying medium would be adjusted to control the heating elements as a function of the difference in boiling temperature, or the time and temperature required to cook the desired food could also be adjusted as a function of the determined air density.

In the example of a convection oven, the issue of air density becomes even more critical. In a convection oven, in which air flow across the product is the cooking medium, the thermal density of the air, which varies with the actual density of the air can affect cook times, and desired effects such as browning or baked goods rising. Therefore, not only are cook temperatures and cook times subject to change as a function of changes in air density, but microprocessor 14 also accounts for, and adjusts, fan speed, damper settings and fan direction to ensure that sufficient amounts of air (the cooking medium) acts on both sides of the food product so that it is properly cooked.

Similarly, in a smoker or an enclosed barbecue microprocessor 14 may change the temperature to affect the density of the smoke reaching the food product. Similarly, damper control may be used to increase the density of smoke to maintain the appropriate flavoring in a lower air density environment.

In yet another embodiment, the cooking parameters to a recipe may be adjusted in step 36, by microprocessor 14 communicating with the library 18. When microprocessor 14 determines that the air density differential is sufficient to require a recipe change, microprocessor 14 transmits the air density information as an air pressure amount, altitude amount, or air density amount, to library 18. Library 18 determines which recipe adjustments are required as a function of the air density information and transmits to microprocessor 14 either values for the parameters to be changed, or an entire replacement recipe. It should also be noted, that library 18 may also store the software algorithm for computing the necessary changes in parameter, and make the algorithm accessible to microprocessor 14 to calculate recipe changes. It should be noted, that if no change is required, this may be treated as a null set; a change calculation indicating that no adjustment is required in step 36.

Once the recipe parameters have been adjusted in step 36, then microprocessor 14 controls the cooking appliance 38 to cook the food in accordance with the adjusted parameters. What is well understood by those skilled in the art, is that the above system and method of operation provide a control for a cooking appliance which better ensures consistency of end product across a variety of environments; and even across a variety of environmental conditions at the same environment. The system and method applies to a wide variety of cooking appliances, such as fryers, convection ovens, smokers, and even the class of cooking appliances considered food preparation devices such as proofers.

With respect to the foregoing embodiments of the invention which have been described, it should be recognized that communications, whether between the appliance, sensor, libraries, microprocessor, or any combination thereof, may be accomplished by any suitable wireless or wired means for the intended application and is a matter of design choice. Preferably, communications are effectuated through wireless communication platforms whose technology is well-established and known to those skilled in the art. More preferably, the wireless communications are performed over the Internet, or the cloud, using established nationwide wireless networks. However, these links may also be conventional, wire based connections such as through standard telecommunication lines, T1 service or the like.

It should also be appreciated by those skilled in the art that individual cooking appliances may be communicating with any of the numerous mobile communication devices. These devices may include, but are not limited to cellular and other wireless communication devices which may be embodied in a phone, laptop or notebook computer, personal digital assistant or the like. Accordingly, for example, these devices may be used as sensors and libraries. These communication devices may effectuate contact with the appliances via cellular, wireless or Internet connections using established nationwide wireless networks or the cloud.

It should further be recognized that the invention is not limited to the particular embodiments described above. Accordingly, numerous modifications can be made without departing from the spirit of the invention and scope of the claims appended hereto. For example, it will also be appreciated by those skilled in the art that the invention is not limited to restaurant applications, but may be employed in any commercial, institutional, or residential application wherein a cooking appliance is used. Moreover, the invention is not limited to use with any particular type of food product or appliance, and will find broad applicability in the food preparation service industry wherever the invention may be feasibly employed. Thus, the invention may be used with ovens, ice machines, refrigerators, fryers, smokers, proofers and the like which may be provided with microprocessor-based controller's to provide a communication interface with the system in network of the invention. Accordingly, these appliances may be cloud enabled to effectuate communications with the system via the Internet.

What is claimed is:

1. A system for controlling a cooking appliance as a function of environmental conditions in which the cooking appliance operates, wherein:
the cooking appliance operating in accordance with a recipe, the recipe including instructions for operating the cooking appliance at a set air density; the system comprising:
an air density detector operatively coupled to the cooking appliance, detecting an air density at the cooking appliance, and outputting an air density signal indicative of the air density at the cooking appliance; and
a microprocessor in communication with the air density detector and the cooking appliance, the microprocessor operating the cooking appliance in accordance with the recipe; the microprocessor selecting an adjustment recipe to operate the cooking appliance in response to the air density signal from the air density detector when the set air density does not equal a value of the air density signal, and the microprocessor operating the cooking appliance in accordance with the adjustment recipe.

2. The system of claim 1, further comprising a library; the library storing at least one of i.) adjustment recipes, each one of the recipes being different from another, as a function of at least one of an altitude of the cooking appliance performing the recipe and the air density at the cooking appliance performing the recipe, ii.) a conversion lookup table for determining changes in parameters of the recipe as a function of at least one of the altitude and air density at the cooking appliance, and c.) an algorithm utilized by microprocessor for calculating changes in parameter of a stored recipe as a function of at least one of the altitude and air density at the cooking appliance.

3. The system of claim 2, wherein the microprocessor is in communication with the library and selects one of an adjustment recipe, a conversion look up table and algorithm, and operates the cooking appliance in accordance therewith.

4. The system of claim 1, wherein the air density detector is a barometer.

5. The system of claim 1, wherein the air density detector is an altimeter.

6. The system of claim 1, wherein the cooking appliance is an oven.

7. The system of claim 1, wherein the cooking appliance is a fryer.

8. The system of claim 1, wherein the cooking appliance is a smoker.
